(19) United States
(12) Patent Application Publication
(10) Pub. No.: US 2006/0218116 A1
(43) Pub. Date: Sep. 28, 2006

(54) Pass-through interface queries to populate a class-based model

(76) Inventors: James Eric O'Hearn, Mission Viejo, CA (US); Mario Brenes, Laguna Niguel, CA (US); Ibrahim el sayed Abouh, Redding, CA (US); David A. Horn, Kingwood, TX (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/221,138

(22) Filed: Sep. 6, 2005

Related U.S. Application Data
(60) Provisional application No. 60/666,032, filed on Mar. 28, 2005.

(51) Int. Cl. G06F 17/30

(52) U.S. Cl. 707/1

(57) ABSTRACT

Some embodiments include reception of a request for data associated with an object instantiation of a component of a class model representing tag-based data and non-tag-based data, the request including user criteria mapped to a member of the component. Embodiments may also utilize an interface and a configuration to query an operational data source for data associated with data fields, wherein one of the data fields is associated with the member of the component, wherein one field of the configuration is associated with the member of the component, and wherein the one field of the configuration includes the user criteria that is mapped to the member of the component. Moreover, data associated with the data fields may be received from the operational data source and the member of the object instantiation may be populated with data of the one of the data fields associated with the member.

### CROSS REFERENCE TO RELATED APPLICATIONS

This application claims priority to Provisional Application Ser. No. 60/666,032, filed Mar. 28, 2005 and entitled “Connecting Third-Party Software to a Tag-Based System”.

### BACKGROUND

1. Field

The embodiments described below relate generally to systems for retrieving operations data using a class-based model.

2. Discussion

Conventional industrial systems often rely to some extent on computer-based automation and monitoring. In some examples of automation and monitoring, data arising from the operation of a manufacturing plant is acquired, analyzed and responded to if necessary. The data may arise from independent sources, with each source configured to provide substantially raw or native “point” data at pre-defined intervals in real or near real-time. The point data may be presented to an operator in real or near-real time, and may include such as numerical values produced by gauges and/or monitors (e.g., speed, temperature, or pressure).

Examples of systems that may acquire, analyze, and act on point data include industrial automation systems, supervisory control and data acquisition (SCADA) systems, and general data acquisition systems. In such systems, point data may be associated with a “tag” to create a structural data element that is made accessible to other components, systems, applications and/or users. In general, point data obtained from selected sources is subject to dynamic change and is monitored and reported through various operations and functions associated with processing the point data. In industrial automation and control systems, decision support and reporting capabilities may be provided based on tag-associated point data that is monitored over very short timeframes ranging in the sub-second to sub-minute range.

Many conventional systems provide only limited capabilities to access, interpret, and/or manipulate tag-based point data collectively or in connection with “non-point” data. Non-point data relates to a broad category of context-providing information that is associated with point data and may extend the functionality and meaning of the point data. Non-point data may include descriptive and/or attribute information characterizing the point data, as well as, other information such as limits, ranges, etc. In conventional systems, integral and flexible manipulation of tag-based point data and non-point data is restricted due to the inherent differences between and properties of the two types of data.

Conventional systems also possess a limited ability to integrate and relate tag-based point data and non-tag-based data. Non-tag-based data may originate from numerous sources and relate to disparate aspects of an enterprise environment. For example, non-tag-based data may comprise data associated with conventional database applications/environments and include transactional information, production data, business data, etc. Conventionally, attempts to integrate non-tag-based data with tag-based point data may be hindered or prevented completely as a consequence of underlying differences in structure and content between these data types. As a result, generating and implementing logical constructions or schema in which both tag-based data and non-tag-based data are integrally used is problematic in conventional systems. Such limitations limit overall flexibility and increase the difficulty of scaling to complex, enterprise-level environments.

The foregoing difficulties in managing tag-based point data, non-point data, and non-tag-based data also hinder efficient caching of such data. Caching may allow a client to efficiently access and/or manipulate the data. However, it may not be desirable to cache all of the data arising from industrial operations due to cache size constraints. Systems for efficiently providing a client with access to non-cached tag-based data and non-tag-based are therefore desired.

Accordingly, such systems would allow a client to directly or indirectly query a data source. Such systems are particularly desired to query data sources that require proprietary queries. Moreover, systems allowing the client to constrain the queries are desired.

### SUMMARY

In order to address the foregoing, some embodiments concern a system, a method, an apparatus, a medium storing processor-executable process steps, and means to receive a request for data associated with an object instantiation of a component of a class model representing tag-based data and non-tag-based data, the request including user criteria mapped to a member of the component. Embodiments may further relate to utilization of an interface and a configuration to query an operational data source for data associated with data fields, wherein one of the data fields is associated with the member of the component, wherein one field of the configuration is associated with the member of the component, and wherein the one field of the configuration includes the user criteria that is mapped to the member of the component. Moreover, data associated with the data fields may be received from the operational data source and the member of the object instantiation may be populated with data of the one of the data fields associated with the member.

According to further aspects, the class model may represent assets and geographies of a manufacturing organization. In some embodiments, the tag-based data and non-tag-based data are derived from an industrial process, which may comprise a continuous process and/or operations of facilities involved in at least one of manufacturing, assembly, natural resource procurement, natural resource refinement, chemical synthesis, water treatment, power generation, power transmission, food processing, beverage processing, raw materials processing, agricultural processing, and materials processing.

The appended claims are not limited to the disclosed embodiments, however, as those in the art can readily adapt the teachings herein to create other embodiments and applications.

### BRIEF DESCRIPTION OF THE DRAWINGS

The construction and usage of embodiments will become readily apparent from consideration of the following specification as illustrated in the accompanying drawings, in which like reference numerals designate like parts, and wherein:

FIG. 1 is a block diagram to illustrate operation of a pass-through interface according to some embodiments;

FIG. 2 illustrates a flow diagram of process steps according to some embodiments;

FIG. 3 is a block diagram to illustrate mapping of user criteria to configuration fields according to some embodiments;

FIG. 4 is a block diagram of a system architecture according to some embodiments;

FIG. 5 is an illustration of a component model according to some embodiments;

FIG. 6 is a block diagram illustrating an internal architecture of an administration device according to some embodiments;

FIG. 7 is a block diagram illustrating an internal architecture of a client device according to some embodiments;

FIG. 8 illustrates a flow diagram of process steps according to some embodiments;

FIG. 9 is an outward view of a user interface according to some embodiments;

FIG. 10 is an outward view of a user interface according to some embodiments;

FIG. 11 is an outward view of a user interface according to some embodiments;

FIG. 12 is an outward view of a user interface according to some embodiments;

FIG. 13 is an outward view of a user interface according to some embodiments;

FIG. 14 is an outward view of a client interface according to some embodiments; and

FIG. 15 is an outward view of a client interface according to some embodiments.

### DETAILED DESCRIPTION

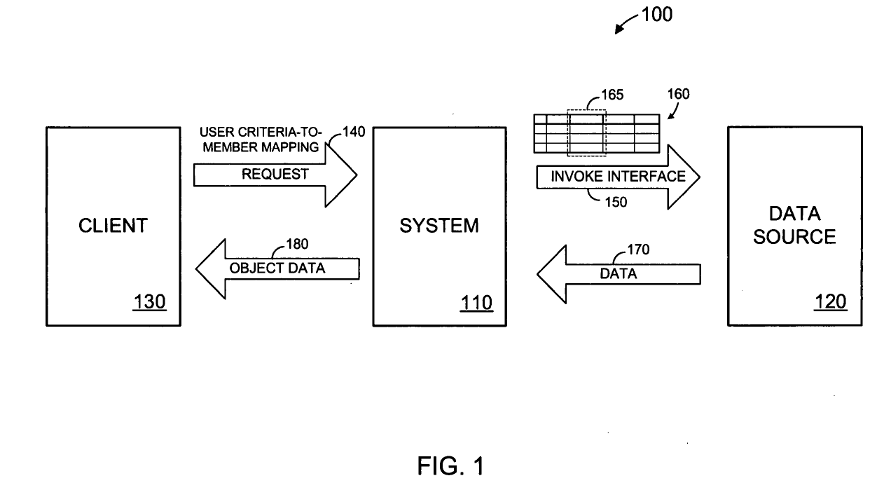

FIG. 1 is a block diagram of system 100 according to some embodiments. Other architectures may be used in conjunction with other embodiments. System 100 includes system 110, data source 120 and client 130. System 110 may comprise any system or systems for querying data source 120 and for receiving data therefrom. System 110 may be used to aggregate real and/or near-real time operations data arising from the operation of an industrial plant and stored in data source 120 based on a component model. Such a component model represents tag-based operations data and non-tag-based operations data that are generated by an industrial process. The operations data may represent any type of operation, including but not limited to batch processes, discrete processes, and/or continuous industrial processes employed in the oil industry (e.g., in an oil refinery), gas industry, and/or chemical industry.

In this regard, the various embodiments described herein can be employed in a wide variety of industries and operational facilities. Any industrial process with differing types of operations data may supply data to systems utilizing the invention. For instance, facilities involved with natural resource refinement and procurement, oil and gas procurement, oil and gas refinement, chemical synthesis and refinement, water treatment, power generation, power transmission, food and beverage processing, raw materials processing (e.g. pulp, lumber, metals, and minerals), agricultural processing and materials processing (e.g. steel mills and foundries) may be suited to utilize platforms and software built upon concepts described herein. Additionally, facilities involved in finished goods manufacturing and production such as product assembly lines may utilize one or more embodiments or systems with such features.

These facilities may have various assets, equipment, machinery, flows etc. that produce operations data which may be continuous or discrete and may involve operations data that is presented in batches. Examples include pumps, motors, tanks, pipelines, mills, lathes, mixers, assembly lines, and so on. Operations data may include data from machinery, assets, process historians, maintenance systems, enterprise resource planning systems and the like. Examples of such data include pressure, temperature, capacities, volumes, rates of flow, production totals, inventories, performance indicators and the like.

“Operations data” as used herein includes tag-based point data, non-point data and non-tag-based data. As used herein, point data may be characterized as current, real-time, or value data associated with one or more instruments, components, or portions of a manufacturing, industrial, commercial, or other system. Any of these instruments, components, or portions may be configured to generate, measure, and/or sample point data of interest. For example, a data acquisition system for a particular instrument or machine may continuously or periodically acquire data reflecting a motor's operating speed and/or operating temperature as point data from a point data source associated with the motor. In certain instances, the point data may be a simple numerical or string value. Point data may further be associated with monitoring, control, and reporting functions of various instruments, components, and applications to provide information relating to the operation of a selected system. This information may also be made available for collection and review by various data acquisition and control systems.

Point data is often acquired in a raw or unstructured form wherein the point data reflects a numerical or string value without supporting details, description, and/or attributes. As previously described, certain types of point data may be associated with real-time or near real-time information (e.g. current temperature, pressure, speed, voltage, current, etc.) that may be desirably sampled, updated or refreshed relatively frequently. The exact frequency of these operations is typically dependent on the characteristics of the point data itself and may be different across the multiple point data sources incorporated into a particular system.

A tag may therefore represent a data structure comprising selected quanta of information associated with a particular point data informational source and may also comprise certain non-point data. In conventional systems, acquisition of each tag's current value (e.g. point data-associated information) generally requires a unique configuration for each tag and possibly for each tag's attributes (e.g. non-point data). Considering that it is not uncommon for complex industrial automation applications to contain upwards of 100,000 tags, it will be appreciated that the individualized configuration and management of tags in the aforementioned manner can be very time consuming, inefficient, and error prone. Furthermore, conventional mechanisms for control, monitoring, or archiving of tag-based information tend to become even less useful when attempting to aggregate such information across multiple systems such as in the context of other plant production systems and applications.

Non-point data may take many forms, including but not limited to, attribute information, parameters, limits and other descriptive information. Certain non-point data may be associated with the point data to provide context thereto. As used herein, the terms point data and non-point data encompass various categories of information that are not necessarily constrained to the examples described herein.

Other types of non-point data may include information such as maintenance work orders (relational data or API (Application Programming Interface) structure data from maintenance systems), equipment documentation (unstructured data usually contained within operating system files and documents), and information such as URL (Uniform Resource Locator) links to supplier web sites. These types of non-point data may be associated with non-tag based information contained, for example, within Oracle™ or SAP™ databases/environments. Non-point data therefore represents a broad class of information that may be associated with point data providing a contextual and informational basis.

Data source 120 may comprise any source of any data that may receive queries from system 110 and provide data to system 110 based on the queries. Data of data source 120 may comprise any type of data in any type of data structure that is or becomes known.

According to some embodiments, data source 120 comprises a back-end data environment employed in an industrial context. Data source 120 may therefore comprise many disparate hardware and software systems, some of which are not interoperational with one another. Data source 120 may comprise plant floor production systems, enterprise resource planning data systems, and any other data systems according to some embodiments. Data arising from data source 120 may be associated with any aspect of industrial operations, and may consist of point data and non-point data used to characterize, contextualize, or identify the point data and/or the source of the point data.

Client 130 may comprise any type of client for requesting data from system 110 and for receiving data therefrom. In some embodiments, client 130 comprises a terminal used by an operator to monitor an industrial plant that generates the data of data source 120.

System 110, data source 120 and client 130 may comprise any number of hardware and/or software elements in communication with one another, some of which are located remote from each other. As used herein, systems “in communication” with one another are directly or indirectly capable of communicating over any number of different systems for transferring data, including but not limited to a local area network, a wide area network, a telephone network, a cellular network, a fiber-optic network, a satellite network, an infrared network, a radio frequency network, and any other type of network that may be used to transmit information between devices. Moreover, communication between systems may proceed over any one or more currently or hereafter-known transmission protocols, such as Asynchronous Transfer Mode (ATM), Internet Protocol (IP), Hypertext Transfer Protocol (HTTP) and Wireless Application Protocol (WAP).

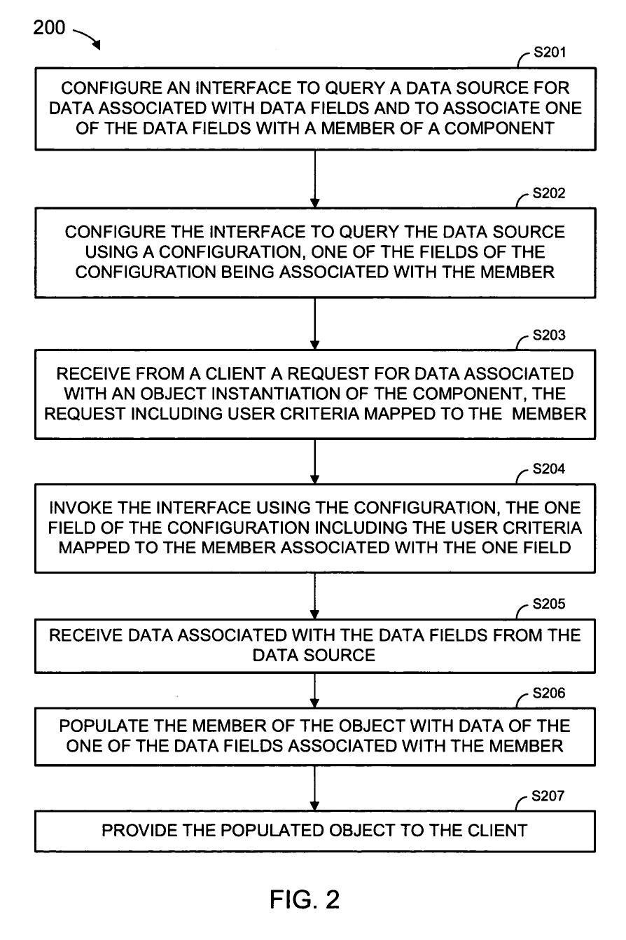

FIG. 2 illustrates process steps 200 for describing an operation of system 100 according to some embodiments. Process steps 200 may be embodied in one or more software or hardware elements and executed, in whole or in part, by any device or by any number of devices in combination, including but not limited to those devices illustrated in FIG. 1. Moreover, some or all of process steps 200 may be performed manually.

Process steps 200 and all other process steps mentioned herein may be embodied in processor-executable process steps read from one or more of a computer-readable medium, such as a floppy disk, a CD-ROM, a DVD-ROM, a Zip™ disk, a magnetic tape, or a signal encoding the process steps, and then stored in a compressed, uncompiled and/or encrypted format. In alternative embodiments, hard-wired circuitry may be used in place of, or in combination with, processor-executable process steps for implementation of processes according to some embodiments. Thus, embodiments are not limited to any specific combination of hardware and software.

Initially, at step S201, an interface is configured to query a data source for data associated with data fields. The interface is also configured to associate one of the data fields with a member of a component. The component may be part of a class model representing tag-based data and non-tag-based data that are generated by a continuous industrial process. According to some embodiments of step S201, the interface comprises an Application Programming Interface (API) that is exposed by data source 120 and that may be invoked by system 110. System 110 may receive input at step S201 specifying data source 120, an interface supported by data source 120, a data structure within data source 120 (e.g., a table) to be queried using the interface, and a mapping between at least one data field returned by the interface and at least one member of a component. A detailed example of step S201 according to some embodiments is provided below.

Next, at step S202, the interface is further configured to query the data source using a configuration. At least one of the fields of the configuration may be associated with the at least one member mentioned with respect to step S201. In this regard, the configuration may comprise structures, class instances, values, tables, and/or any other data types used to constrain the interface. According to some embodiments, the configuration may include “import parameters”, which comprise a structure-like construct used to configure an SAP Business Application Interface (BAPI)® prior to invocation.

At least one of the data fields of the configuration is associated with the member of the component. Accordingly, the data field may specify a variable that represents the member, rather than a specific value for constraining the interface. A system to associate data fields of the configuration with the component member is also described in detail below. Step S202 may also comprise associating specific values with other data fields or elements of the configuration.

A request for data is received from a client at step S203. The requested data is associated with an object instantiation of the component. The request also includes user criteria mapped to the at least one member of the component.

Arrow 140 of FIG. 1 represents a request received from client 130 according to some embodiments of step S203. In some embodiments, client 130 receives a command to present a view of an object that is an instantiation of the component mentioned above. The view may include some data that is not cached by system 110 and that must be acquired from data source 120. As illustrated, the request includes a user-criteria to member mapping. The mapping specifies a user criterion as well as an associated member of the component.

The interface is invoked at step S204 using the configuration. For the invocation, the one field of the configuration that is associated with the component member includes the user criterion that is mapped to the member by the received criteria-to-member mapping. According to some embodiments, the user criterion is matched with the configuration field by comparing the value of the configuration field with the member name associated with the user criterion. System 110 may use standardized or proprietary mechanisms to invoke the interface 125 as shown by arrow 150 in FIG. 1.

The interface is invoked in conjunction with configuration 160. Although configuration 160 is illustrated in tabular format, some embodiments employ any currently- or hereafter-known data structure. Configuration 160 includes configuration field 165 that was associated with a component member in step S202. Configuration field 165 is populated with the user criterion that is mapped to the same component member by the criteria-to-member mapping.

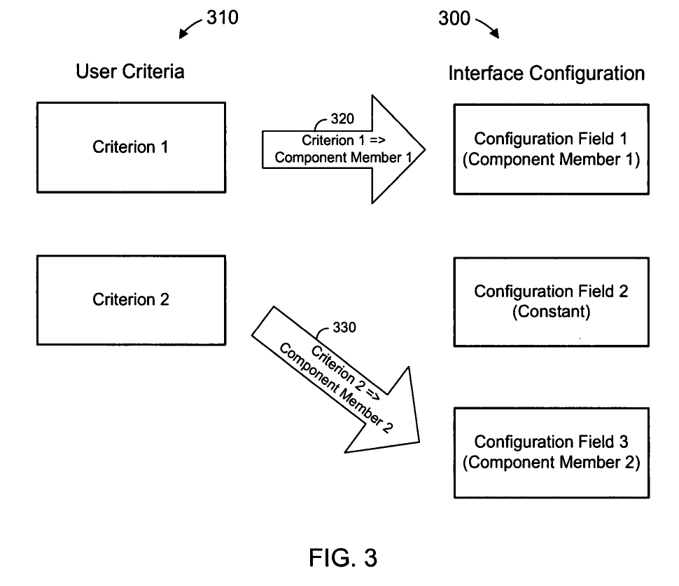

FIG. 3 is a block diagram to illustrate some embodiments of step S204. Interface configuration 300 is defined at step S202 and includes configuration fields. The configuration fields may comprise actual values as shown with respect to Configuration Field 2 or variables that identify a component member. User criteria 310 include user criteria received from client 130 with the request at step S203. Arrows 320 and 330 represent criteria-to-member mappings also received with the request. Specifically, arrow 320 indicates that Criterion 1 should populate the configuration field that is associated with Component Member 1, and arrow 330 indicates that Criterion 2 should be populate the configuration field that is associated with Component Member 2.

Data associated with the data fields is received from data source 120 at step S205. The received data is represented by arrow 170 of FIG. 1. Next, at step S206, the member of the object is populated with data of the data field that was associated with the member at step S201.

The object may comprise a collection object, in which case the data received at step S205 may include several records. Accordingly, if the received data includes N records, system 110 populates the member of each of N different object instances with the data value of the associated field from a respective one of the N records.

The populated object is provided to the client at step S207. Arrow 180 of FIG. 1 illustrates step S207 according to some embodiments. Client 130 may present some or all of the received data to a user in any suitable manner.

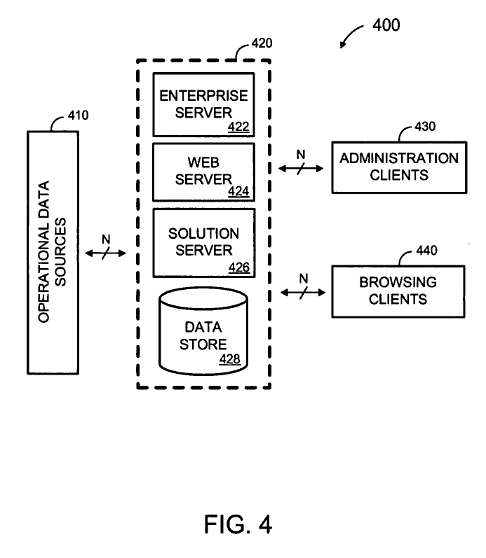

FIG. 4 illustrates an architecture of system 400 according to some embodiments. It should be noted that other architectures may be used in conjunction with other embodiments. System 400 includes operational data sources 410 in communication with application environment 420. Also in communication with application environment 420 are administration clients 430 and browsing clients 440.

Operational data sources 410 comprise various data sources, including but not limited to plant floor production systems, enterprise resource planning data systems, and other data systems. Operational data sources 410 may support one or more proprietary interfaces for accessing the data stored therein. An example of such an interface according to some embodiments is an SAP® BAPI®. Operational data sources 410 may also provide one or more non-proprietary mechanism for accessing stored data. The stored data may represent any type of operation, including but not limited to continuous industrial processes employed in the oil, gas, and/or chemical industries.

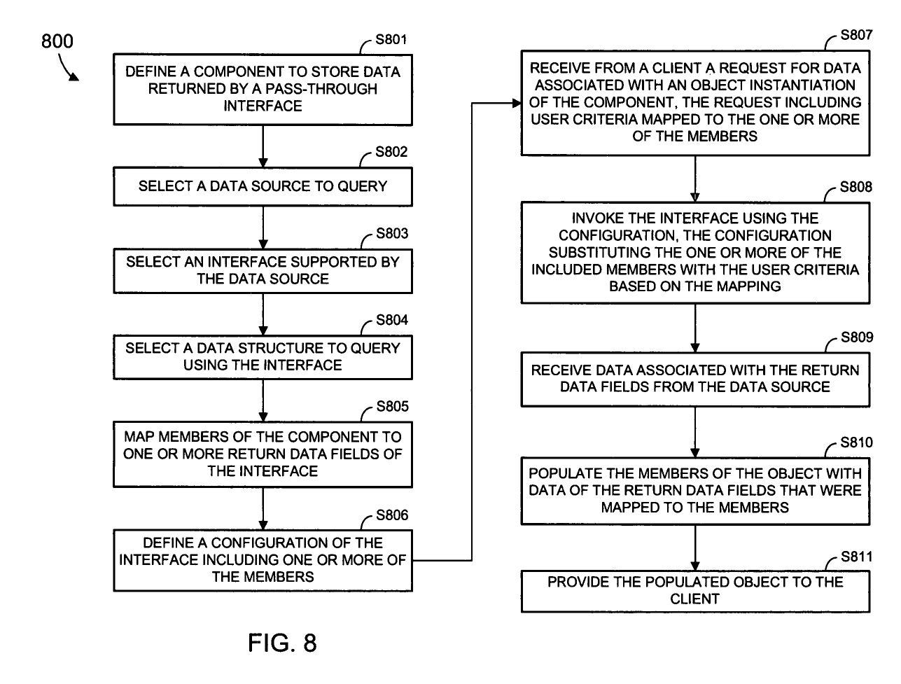

Application environment 420 may transmit queries for data to operational data sources 410. In response, operational data sources 410 acquire and transmit the data to application environment 420. An example of this operation according to some embodiments is illustrated in FIG. 1 and described above with respect to FIG. 2. The operation of system 400 according to some embodiments of process steps 200 will be described below with respect to FIG. 8.

Application environment 420 may comprise enterprise server 422, Web server 424, solution server 426, and data store 428. Application environment 420 may comprise a single server device or multiple devices. In various embodiments, enterprise server 422 and solution server 426 comprise application programs developed in Java and/or C++ and running under Windows XP/NT/2000/2003.

Web server 424 manages data communication between application environment 420, administration clients 430, and browsing clients 440. One or more administration clients 430 and browsing clients 440 may execute one or more Java applets to interact with Java servlets of Web server 424 according to some embodiments.

Solution server 426 is used to access data from operational data sources 410. In some embodiments, solution server 426 includes connection groups and connection processes. A connection group includes one or more object instances, each of which is associated with a particular data source of operational data sources 410. Different connection groups are associated with different data sources.

A connection process comprises processor-executable process steps to retrieve data from a particular type of data source (e.g., an SAP R/3™ server). A connection process may comply with standard or proprietary protocols, including but not limited to Oracle Database Connectivity (ODBC), Java Database Connectivity (JDBC), Object Linking and Embedding for Process Control (OPC), and Web Services. Process steps to retrieve data from a particular type of data source may be provided in a library by an owner of a proprietary interface for accessing the particular type of data source.

Accordingly, several different connection groups may use a same connection process to access their respective data sources. Moreover, each object instance may include scripts (e.g. Structured Query Language scripts) to populate itself based on retrieved data. Solution server 426 manages the objects, connection groups and connection processes to access data that is acquired and stored by disparate systems of operational data sources 410.

Solution server 426 may transmit the data acquired from operational data sources 410 to data store 450 for storage according to some embodiments. Data store 450 may store any data used during the operation of application environment 420. Data may be stored in data store 450 according to any currently- or hereafter-known protocol for storing data, including but not limited to a class-based component and view model. Data store 450 may comprise a front-end application that is usable to access and/or manage the data stored therein. Such a front-end application may support Structured Query Language commands or the like. According to some embodiments, data store 450 may receive data directly from operational data sources 410.

Administration clients 430 may provide user interfaces to perform administration functions for operating system 400. For example, an administrator may manipulate a user interface displayed by one of administration clients 430 to configure an interface as described with respect to process steps 200. Information input to the user interfaces may be received by Web server 424 and transmitted to data store 428. Examples of administration clients 430 according to some embodiments include but are not limited to a desktop computer, a laptop computer, a computer terminal, a personal digital assistant, a telephone, and a tablet computer.

Browsing clients 440 may request views of data contained in data store 428 and/or in operational data sources 410. In the latter case, browsing clients 440 may receive user criteria from a user and transmit the user criteria to environment 420 along with a request for a view. Browsing clients 440 may provide any suitable client application such as a Web browser or a Java applet. As such, a browsing client 440 may be connected to application environment 420 through the Internet or through an Intranet. Browsing clients 40 may comprise any suitable user devices, including but not limited to those mentioned above with respect to administration clients 430.

In some embodiments, the elements of FIG. 4 are connected differently than as shown, and each block shown is implemented by one or more hardware and software elements. The hardware and software elements of one or more blocks may be located remotely from each other. Some embodiments may include environments, systems, servers, and clients that are different from those shown.

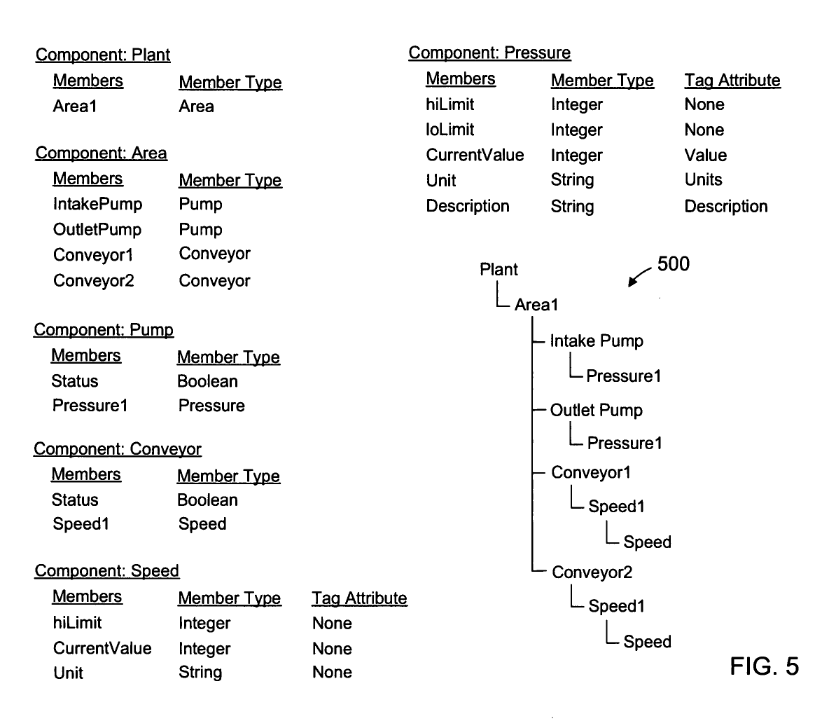

FIG. 5 illustrates component model 500 according to some embodiments. Application environment 420 may store and manage component model 500 to represent tag-based data and non-tag-based data that are generated by a continuous industrial process. In this regard, data store 428 stores data in the form of objects instantiated based on components of component model 500.

In some embodiments, the tag-based data may be generated by and received from SCADA, HMI, DCS, plant historians, etc., and the non-tag-based data may be generated by and received from business systems and applications (e.g.,SAP (ERP), Oracle Manufacturing Apps, general database apps, etc). Moreover, component model 500 may represent assets and geographies of a plant or manufacturing organization.

Commonly-assigned U.S. Pat. No. 6,700,590 describes a system to use a class-based object and view model to collect and display data received from multiple heterogeneous sources. This system encapsulates received tag-based data and non-tag-based data as objects, which are instantiations of defined components. The use of components and objects may provide reusability, consistency, inheritance and other benefits known to those familiar with object-oriented techniques. Component model 500 may be established and utilized in any manner, including but not limited to those specified in aforementioned U.S. Pat. No. 6,700,590 and/or U.S. Patent Application Publication No. 2005/0144154, the contents of which are herein incorporated by reference for all purposes. Component model 500 may follow any suitable modeling protocol or format; including those mentioned in the foregoing references.

Each component of component model 500 includes at least one member, and each component member is associated with a member type. A member of a first component may be a second component, in which case the associated member type is the name of the second component. All members that are associated with “primitive” member types (which include anything other than another component) are either associated with a tag attribute or not (i.e. “None”).

Component model 500 of FIG. 5 is shown in a tree or hierarchical format which facilitates visualization and understanding of the relationships and patterns of inheritance/instantiations for the various component definitions of FIG. 5. Component model 500 may therefore be displayed to an administrator or user according to some embodiments. In the illustrated embodiment, only components whose members are not associated with tag attributes are displayed in component model 500.

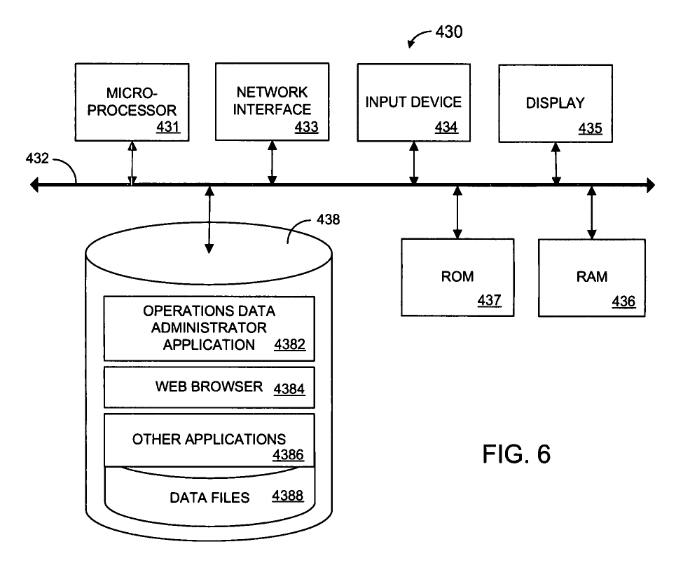

FIG. 6 is a block diagram of an internal architecture of administration client 430 according to some embodiments. Administration client 430 may operate to configure an interface to query a data source of data sources 410 for data associated with data fields and to associate one of the data fields with a member of a component, and to configure the interface to query the data source using a configuration.

Administration client 430 includes microprocessor 431 in communication with communication bus 432. Microprocessor 431 may comprise an Intel Itanium™ microprocessor or other type of processor and is used to execute processor-executable process steps so as to control the elements of administration client 430 to provide desired functionality.

Also in communication with communication bus 432 is network interface 433. Network interface 433 is used to transmit data to and to receive data from devices external to administration client 430 such as a device housing Web server 424. Network interface 433 is therefore preferably configured with hardware suitable to physically interface with desired external devices and/or network connections. For example, network interface 433 may comprise an Ethernet connection to a local area network through which administration device 430 may receive and transmit information over the Web.

Input device 434 and display 435 are also in communication with communication bus 432. Any known input device may comprise input device 434, including a keyboard, mouse, touch pad, voice-recognition system, or any combination of these devices. Of course, information may also be input to administration device 430 via network interface 433. Display 435 may be an integral or separate CRT display, flat-panel display or the like used to present graphics and text in response to commands issued by microprocessor 431.

According to some embodiments, display 435 displays user interfaces that may be manipulated by an administrator using input device 434 to configure an interface as described herein. Some examples of such user interfaces are described below.

RAM 436 is connected to communication bus 432 to provide microprocessor 431 with fast data storage and retrieval. In this regard, processor-executable process steps being executed by microprocessor 431 are typically stored temporarily in RAM 436 and executed therefrom by microprocessor 431. ROM 437, in contrast, provides storage from which data can be retrieved but to which data cannot be stored. Accordingly, ROM 437 may be used to store invariant process steps and other data, such as basic input/output instructions and data used during boot-up of administration device 430 or to control network interface 433. One or both of RAM 436 and ROM 437 may communicate directly with microprocessor 431 instead of over communication bus 432.

Data storage device 438 stores, among other data, processor-executable process steps of operations data administrator application 4382. Administration device 430 may execute process steps of operations data administrator application 4382 to provide the functions attributed herein to administrator client 430. Operations data administrator application 4382 may comprise a Java applet or a standalone application suitable for the operating system of administration device 4382.

Web browser 4384 may comprise processor-executable process steps of a Web client. As such, administration client 430 may execute process steps of Web browser 4384 to request and receive Web pages from a Web server such as Web server 424. A Java applet such as operations data administrator application 4382 may execute within an execution engine provided by Web browser 4384.

Data storage device 438 also includes processor-executable process steps of other applications 4386. Other applications 4386 may include process steps to perform calendaring, e-mail functions, word processing, accounting, presentation development and the like. Data storage device 438 may also store process steps of an operating system (unshown). An operating system provides a platform for executing applications, device drivers and other process steps that interact with elements of administration client 430. Data files 4388 may include any electronic files usable by any application of administration client 430.

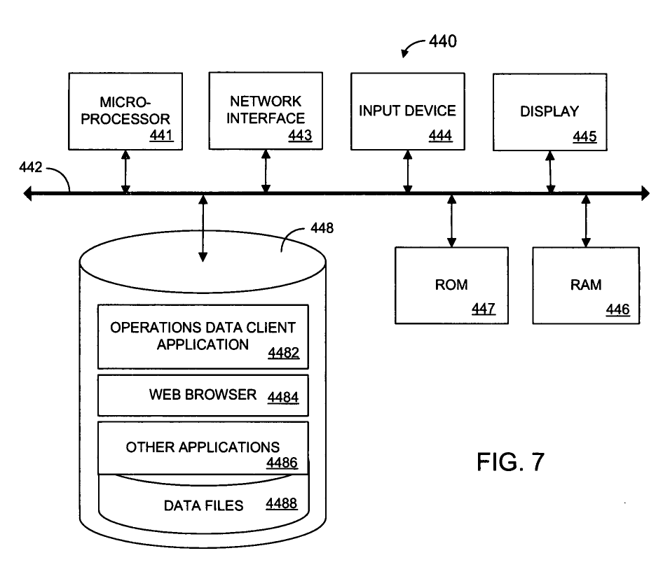

FIG. 7 is a block diagram of an internal architecture of browsing client 440 according to some embodiments. The illustrated elements of browsing client 440 may be implemented as described above with respect to similarly-named elements of administration client 440. Of course, the elements of browsing client 440 may operate to provide the functionality attributed herein to browsing client 440. For example, browsing client 440 may operate to receive user criteria from a user, to request a view from application environment 420, to receive data from data sources 410 via application environment 420, and to present the data to user.

Data storage device 4480 of browsing client 440 stores, among other data, processor-executable process steps of operations data client application 4482. Operations data client application 4482 may comprise a Java applet or a standalone application suitable execution by the operating system of browsing client 440.

Web browser 4484 may comprise processor-executable process steps of a Web client. As such, browsing client 440 may execute process steps of Web browser 4484 to request and receive Web pages from a Web server such as Web server 424. A Java applet such as operations data client application 4482 may execute within an execution engine provided by Web browser 4484.

The process steps stored in data storage devices 438 and 448 may be read from one or more of a computer-readable medium, such as a floppy disk, a CD-ROM, a DVD-ROM, a Zip™ disk, a magnetic tape, or a signal encoding the process steps, and then stored in data storage devices 438 and 448 in a compressed, uncompiled and/or encrypted format. In alternative embodiments, hard-wired circuitry may be used in place of, or in combination with, processor-executable process steps for implementation of processes according to some embodiments. Thus, embodiments are not limited to any specific combination of hardware and software.

FIG. 8 illustrates process steps 800 according to some embodiments. Process steps 800 may be embodied in one or more software or hardware elements and executed, in whole or in part, by any device or by any number of devices in combination, including by application environment 420.

Initially, a component data is defined at step S801. The component is to store data returned by a pass-through interface as will be described below. The component may comply with a class-based component and view protocol such as that described in above-mentioned U.S. Pat. No. 6,700,590, but embodiments are not limited thereto. The component may comprise a class from which one or more objects may be instantiated as is known in object-oriented programming.

The component may be defined in any suitable manner that is or becomes known. According to some embodiments, an administrator operates input device 434 of administration client 430 to specify a component name and one or more members of the component. The defined component may include scripts to populate itself based on retrieved data, and may be added to a component model such as component model 500 of FIG. 5.

A data source is selected in step S802. The selected data source is to be queried using an interface as described with respect to process steps 200. The data source may comprise any system for storing data. According to some embodiments, the selected data source supports proprietary interfaces for accessing the data stored therein.

The data source may be selected at step S802 by selecting a connection process and/or a connection group. As described above, different connection groups are associated with different data sources, and a connection process may be associated with one or more connection groups.

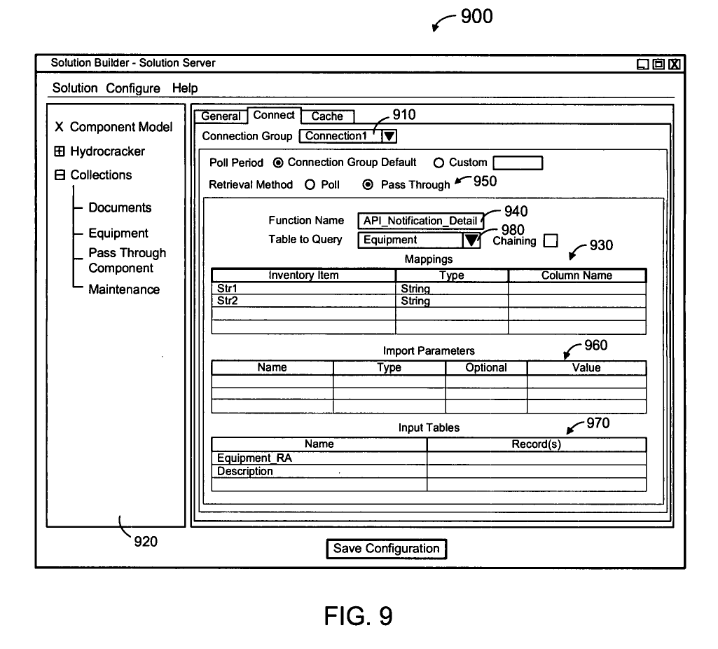

FIG. 9 is an outward view of user interface 900 that may be used in conjunction with some embodiments of step S802. User interface 900 may be presented to an administrator on display 435 of administration client 430. More specifically, administration client 430 may execute operations data administrator application 4382 to request access to a configuration utility served by application environment 420. In some embodiments, administration client 430 executes Web browser 4384 to request access from Web server 424 of application environment 420.

Application environment 420 may perform any required authentication and/or security checks before transmitting user interface 900 (e.g., as a Web page) to administration client 430. Embodiments are not limited to the function, appearance or arrangement of the user interfaces described herein.

User interface 900 includes connection group field 910 for specifying a connection group (and a respective data source) to query. The connection group is associated with a data source and also with a connector process for accessing the data source. The connector process may comprise proprietary process steps usable to invoke proprietary interfaces supported by the data source. The proprietary process may be provided in a library (e.g., a Java Connector library) available to application environment 420.

User interface 900 also includes component area 920 for displaying a component model. The component model is expanded to present a component “Pass Through Component” that was defined in step S801 according to the present example. The component has been selected, and therefore its members are presented in as Inventory Items in Mappings table 930 of interface 900. Also displayed are data types associated with each member.

An interface supported by the data source is selected in step S803. The interface may comprise an API that is exposed by the selected data source and that may be invoked by application environment 420. The interface is selected in the present example by populating function name field 940 with a name of the interface. The administrator may also select one of the radio buttons of Retrieval Method input area 950 to indicate that the interface is to be configured as a pass through interface.

Import parameters interface 960 and input tables interface 970 display configuration information to be used when invoking the specified interface. In the present example, the specified interface does not require any import parameters but may require configuration of one or more input tables. Some interfaces may be associated with both import parameters and input tables, and other interfaces may be associated only with import parameters. Any type of data structure may be in an interface configuration according to some embodiments.

At step S804, the administrator selects a data structure to query using the interface. According to some embodiments, the interface is capable of querying a particular set of tables. These tables are listed by and selectable via pull-down menu 980.

One or more members of the selected component are mapped to one or more return data fields of the interface at step S805. The return data fields comprise fields of each record returned by the interface. To perform this mapping according to some embodiments, the administrator first selects an empty field in the Column Name column of table 930.

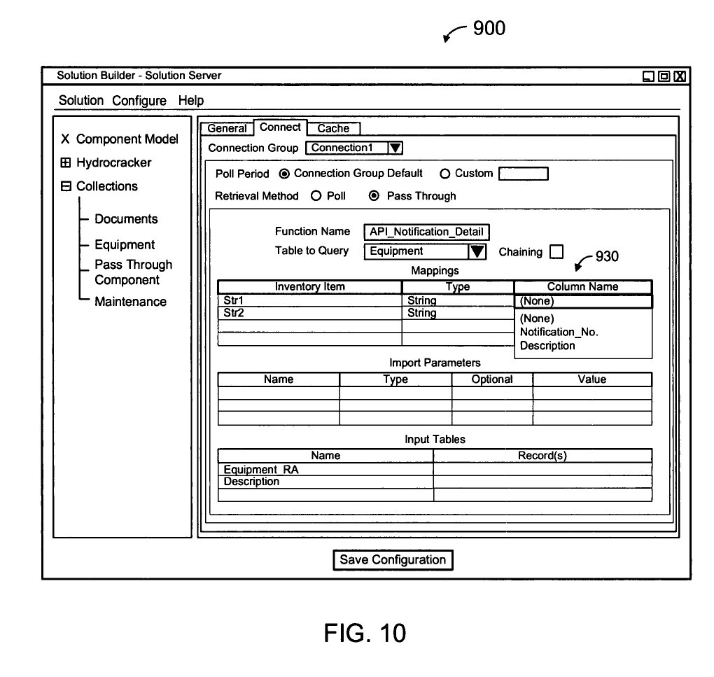

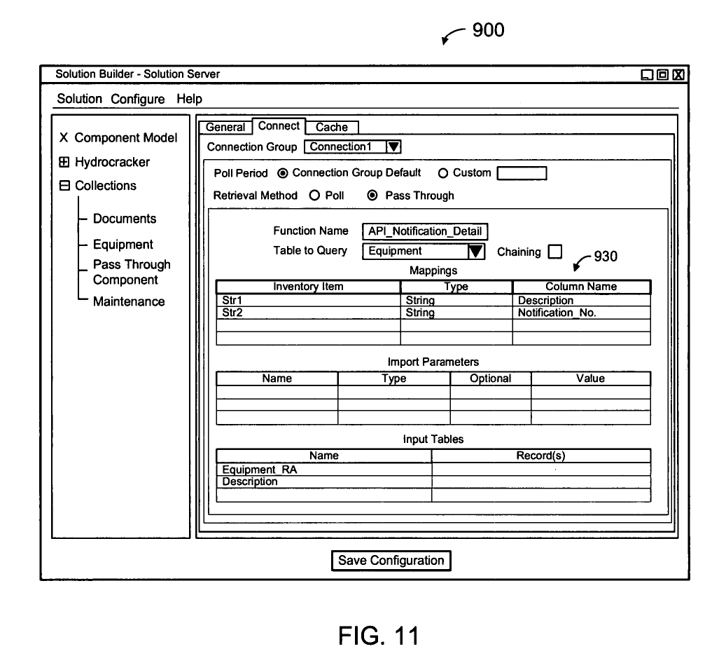

FIG. 10 is a view of user interface 900 after selection of the empty field. As shown, a pull-down menu is displayed including names of the return data fields associated with the interface. The empty field may be populated by selecting one of the displayed names. By populating the Column Name field of a particular row with a data field name, the data field is mapped to the component member associated with the particular row. FIG. 11 is a view of interface 900 after mapping two members of the component to two return data fields of the interface.

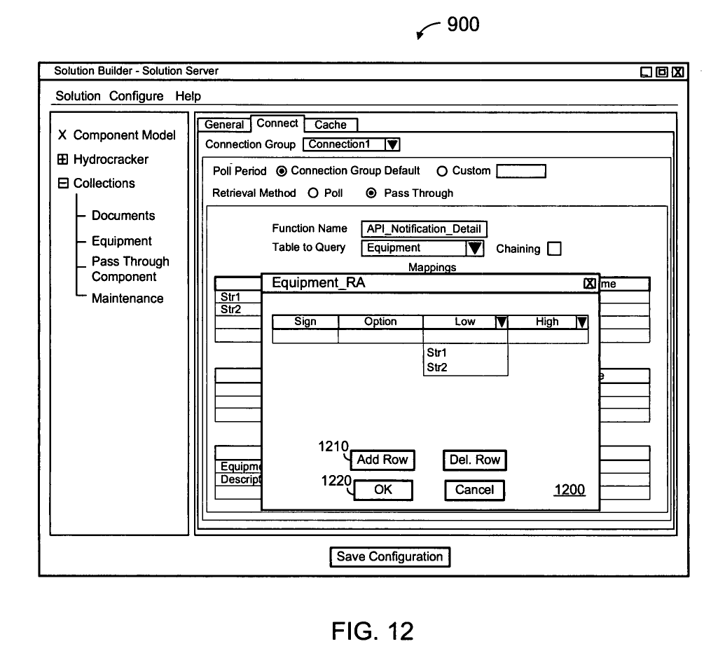

A configuration of the interface is defined at step S806. Accordingly, steps S806 may comprise assigning values to one or more configuration fields of the interface. In the present example, the administrator selects a field in the Record(s) column of table 970 and is presented with a window as shown in FIG. 12.

Window 1200 is used to receive values for the input table associated with the selected field of the Record(s) column. More specifically, window 1200 allows the administrator to specify values for configuration fields that will be used to invoke the interface. According to the illustrated embodiment, the Low and High fields comprise pull-down menus from which the administrator can select from the component members listed among the Inventory Items of table 930. The Option field may allow the administrator to specify an option switch associated with the interface. Moreover, button 1210 allow the administrator to add rows, and therefore additional configuration fields, to the input table. According to some embodiments, a configuration field that is associated with a component member may also be assigned a default value to be used when invoking the interface if no user criterion associated with the component member is available.

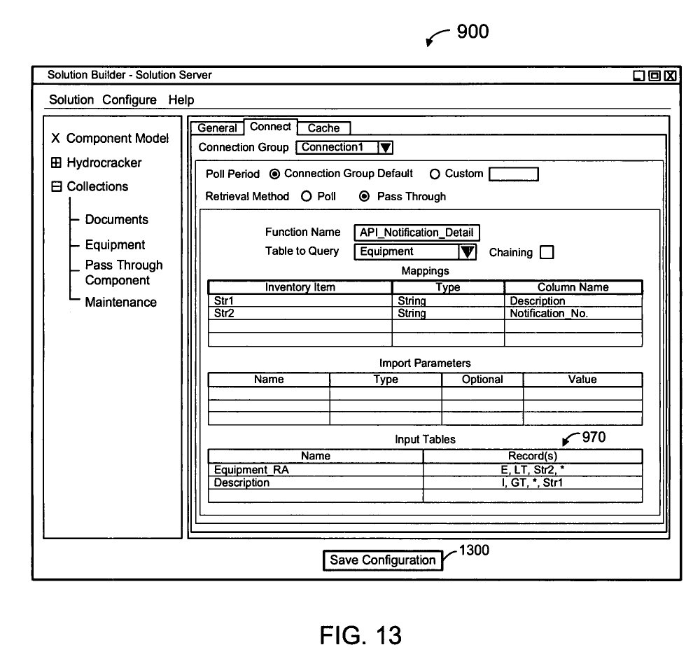

After the values are specified in window 1200 and OK icon 1220 is selected, the appropriate field of table 970 is populated with the specified values as shown in FIG. 13. The configuration may be saved to solution server 426 by selecting Save Configuration button 1300.

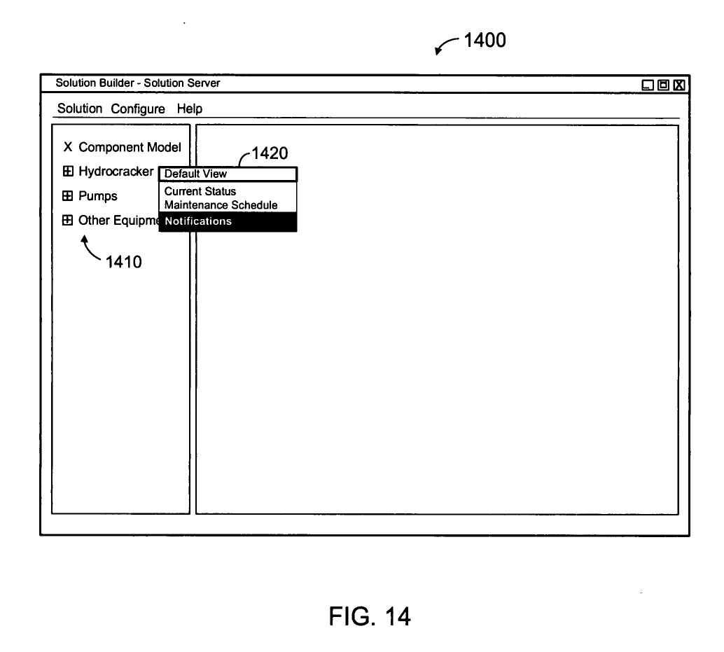

A request for data is received from a client at step S807. The requested data is associated with an object instantiation of the component. The request also includes user criteria mapped to one or more members of the component. According to some embodiments of step S801, a user operates browsing client 440 to execute application 4482. As a result, user interface 1400 of FIG. 14 is displayed by display 445.

User interface 1400 includes navigation tree 1410 for navigating a component model. Tree 1410 displays collections of object instantiations within the component model according to some embodiments. The component model may be presented using a tab metaphor or any other suitable presentation system.

A user operates input device 444 to expand tree 1410 and/or to select a collection view. FIG. 14 shows context menu 1420 that may be displayed in response to a “right-click” on the Hydrocracker collection. In the present example, it will be assumed that the Hydrocracker collection includes an object instantiation of the Pass Through component described above. Menu 1420 displays selectable views associated with the collection.

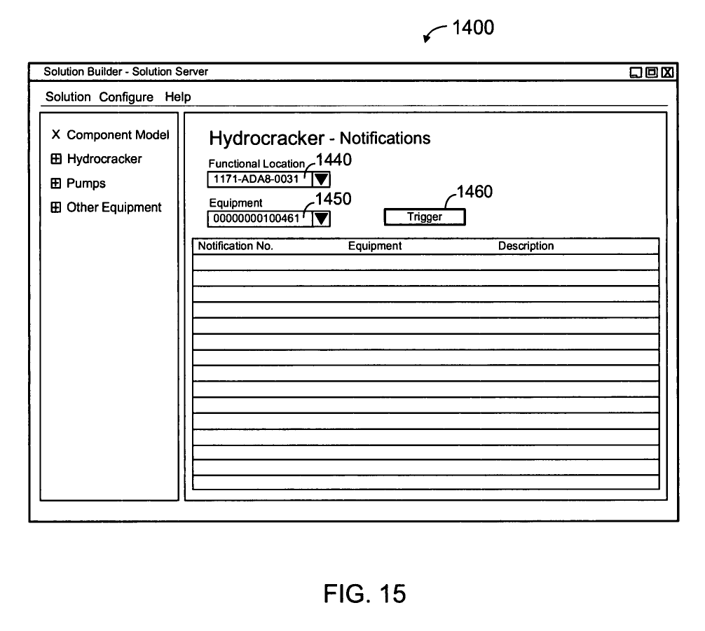

FIG. 15 shows user interface 1400 after user selection of the Notifications view from menu 1420. Interface 1400 includes view area 1430 in which the requested view will be displayed. Area 1430 includes field 1440 and field 1450 for receiving user criteria from the user. The user may input criteria to fields 1440 and 1450 in order to constrain the data that will be displayed in the view.

More specifically, the user criteria of field 1440 may be associated with one of the component members that was associated with a configuration data field in table 970. Similarly, the user criteria of field 1450 may be associated with a second one of the component members that was associated with a second configuration data field in table 970. The user need not be aware of these associations during step S807.

The user criteria and a request for the data are transmitted to application environment 420 upon user selection of Trigger button 1460. Also transmitted is a mapping of each of the user criteria to a component member of the Pass Through component.

The interface is invoked at step S808 using the defined configuration. Application environment 420 may execute proprietary process steps of a connector process to invoke the interface at step S808. According to some embodiments, application environment 420 initially determines that the subject component is associated with a pass through retrieval method as specified during configuration of the component. Environment 420 therefore populates the fields of the configuration that are associated with a particular component member with a user criterion that is mapped to the particular member according to the received criteria-to-member mapping.

Data associated with the return data fields of the interface is received from the data source at step S809. Each record includes data for a plurality of fields such as those illustrated in the pull-down field of table 930 shown in FIG. 9. In this regard, data of a particular field may be associated with the component member that was mapped to the field at step S805.

The object instantiation is populated with the received data at step S810. Application environment 420 may populate the object members with the received data based on the object member/returned data field mapping established at step S805.

The populated object is provided to the client at step S811. As mentioned above, the object may comprise a collection object including several object instantiations. Browsing client 440 may present the data populating each member of each instantiation in view area 1430.

According to some embodiments, the request received at step S807 includes a number of desired records. This number may correspond to a display capacity of area 1430. Therefore, application environment 420 may provide only the desired number of records to browsing client 440 at step S811. Such a constraint may reduce a load on system 400 that may otherwise result from process steps 800.

Those in the art will appreciate that various adaptations and modifications of the above-described embodiments can be configured without departing from the scope and spirit of the claims. Therefore, it is to be understood that the claims may be practiced other than as specifically described herein.

What is claimed is:

1. A method comprising:
receiving a request for data associated with an object instantiation of a component of a class model representing tag-based data and non-tag-based data, the request including user criteria mapped to a member of the component;
utilizing an interface and a configuration to query an operational data source for data associated with data fields, wherein one of the data fields is associated with the member of the component, wherein one field of the configuration is associated with the member of the component, and wherein the one field of the configuration includes the user criteria that is mapped to the member of the component;
receiving data associated with the data fields from the operational data source; and
populating the member of the object instantiation with data of the one of the data fields associated with the member.

2. A method according to claim 1, wherein the request is received from a client, and further comprising:
providing the populated object instantiation to the client.

3. A method according to claim 1,
wherein the request includes second user criteria mapped to a second member of the component,
wherein a second one of the data fields is associated with the second member,
wherein a second one of the fields of the configuration is associated with the second member,
wherein, when utilizing the interface and the configuration, the second field of the configuration includes the second user criteria that is mapped to the second member, and
further comprising populating the second member of the object instantiation with data of the second one of the data fields associated with the second member.

4. A method according to claim 1, further comprising:
determining, in response to the request, that the object instantiation is associated with a pass-through component.

5. A method according to claim 1, wherein the interface is a business application interface supported by the data source.

6. A method according to claim 1, wherein the class model represents assets and geographies of a manufacturing organization.

7. A method according to claim 1, wherein the tag-based data and non-tag-based data are derived from an industrial process.

8. A method according to claim 7, wherein the industrial process comprises a continuous process.

9. A method according to claim 7, wherein the industrial process comprises operations of facilities involved in at least one of manufacturing, assembly, natural resource procurement, natural resource refinement, chemical synthesis, water treatment, power generation, power transmission, food processing, beverage processing, raw materials processing, agricultural processing, and materials processing.

10. A method according to claim 9, wherein the natural resource comprises at least one of oil and natural gas.

11. An apparatus comprising:
a memory storing processor-executable process steps; and
a processor in communication with the memory and operative in conjunction with the stored process steps to:
receive a request for data associated with an object instantiation of a component of a class model representing tag-based data and non-tag-based data, the request including user criteria mapped to a member of the component;
utilize an interface and a configuration to query an operational data source for data associated with data fields, wherein one of the data fields is associated with the member of the component, wherein one field of the configuration is associated with the member of the component, and wherein the one field of the configuration includes the user criteria that is mapped to the member of the component;
receive data associated with the data fields from the operational data source; and
populate the member of the object instantiation with data of the one of the data fields associated with the member.

12. An apparatus according to claim 11, wherein the request is received from a client, and the processor is further operative in conjunction with the stored process steps to:
provide the populated object instantiation to the client.

13. An apparatus according to claim 11,
wherein the request includes second user criteria mapped to a second member of the component,
wherein a second one of the data fields is associated with the second member,
wherein a second one of the fields of the configuration is associated with the second member,
wherein, when the interface and the configuration are utilized, the second field of the configuration includes the second user criteria that is mapped to the second member, and
wherein the processor is further operative in conjunction with the stored process steps to populate the second member of the object instantiation with data of the second one of the data fields associated with the second member.

14. An apparatus according to claim 11, wherein the interface is a business application interface supported by the data source.

15. An apparatus according to claim 11, wherein the processor is further operative in conjunction with the stored process steps to:
determine, in response to the request, that the object instantiation is associated with a pass-through component.

16. An apparatus according to claim 11, wherein the class model represents assets and geographies of a manufacturing organization.

17. An apparatus according to claim 11, wherein the tag-based data and non-tag-based data are derived from an industrial process.

18. An apparatus according to claim 17, wherein the industrial process comprises a continuous process.

19. An apparatus according to claim 17, wherein the industrial process comprises operations of facilities involved in at least one of manufacturing, assembly, natural resource procurement, natural resource refinement, chemical synthesis, water treatment, power generation, power transmission, food processing, beverage processing, raw materials processing, agricultural processing, and materials processing.

20. An apparatus according to claim 19, wherein the natural resource comprises at least one of oil and natural gas.

21. A medium storing computer-executable program code, the program code comprising:
code to receive a request for data associated with an object instantiation of a component of a class model representing tag-based data and non-tag-based data, the request including user criteria mapped to a member of the component;
code to utilize an interface and a configuration to query an operational data source for data associated with data fields, wherein one of the data fields is associated with the member of the component, wherein one field of the configuration is associated with the member of the component, and wherein the one field of the configuration includes the user criteria that is mapped to the member of the component;
code to receive data associated with the data fields from the operational data source; and
code to populate the member of the object instantiation with data of the one of the data fields associated with the member.

22. A medium according to claim 21,
wherein the request includes second user criteria mapped to a second member of the component,
wherein a second one of the data fields is associated with the second member,
wherein a second one of the fields of the configuration is associated with the second member,
wherein, when the interface and the configuration are utilized, the second field of the configuration includes the second user criteria that is mapped to the second member, and
wherein the program code further comprises code to populate the second member of the object instantiation with data of the second one of the data fields associated with the second member.

23. A medium according to claim 21, wherein the tag-based data and non-tag-based data are derived from an industrial process comprising operations of facilities involved in at least one of manufacturing, assembly, natural resource procurement, natural resource refinement, chemical synthesis, water treatment, power generation, power transmission, food processing, beverage processing, raw materials processing, agricultural processing, and materials processing.
